(19) United States
(12) Patent Application Publication
(10) Pub. No.: US 2026/0086522 A1
(43) Pub. Date: Mar. 26, 2026

(54) METHOD AND SYSTEM FOR CONTROLLING AND DISTRIBUTING WAVE ENERGY IN OFFSHORE AQUACULTURE

(71) Applicant: GUANGDONG OCEAN UNIVERSITY, Zhanjiang (CN)

(72) Inventors: Guanglin WU, Zhanjiang (CN); Suijun WANG, Zhanjiang (CN); Mingxian WANG, Zhanjiang (CN); Hui YANG, Zhanjiang (CN); Huiling ZHANG, Zhanjiang (CN); Hongfei MAO, Zhanjiang (CN); Yanli HE, Zhanjiang (CN); Zhenglin TIAN, Zhanjiang (CN); Jinbo LIN, Zhanjiang (CN); Zhangfeng YANG, Zhanjiang (CN); Yingchao MA, Zhanjiang (CN); Jintao XU, Zhanjiang (CN); Huahao YU, Zhanjiang (CN)

(21) Appl. No.: 19/409,763

(22) Filed: Dec. 5, 2025

Related U.S. Application Data
(63) Continuation of application No. PCT/CN2025/111061, filed on Jul. 29, 2025.

(30) Foreign Application Priority Data
Aug. 9, 2024 (CN) 202411089112.9

(51) Int. Cl. G05B 19/042

(52) U.S. Cl. CPC G05B 19/042; G05B 2219/2639

(57) ABSTRACT

Disclosed in the present disclosure is a method and system for controlling and distributing wave energy in offshore aquaculture. The method includes: obtaining an aquaculture cycle of each aquaculture sub-zone of an offshore aquaculture zone, sorting remaining aquaculture cycles of the aquaculture sub-zones from small to large, and obtaining a plurality of work cycles according to sorting results; obtaining a predicted wave energy yield of a next work cycle through a preset neural network model; obtaining an importance coefficient value sorting result of each aquaculture zone through a preset recursive feature elimination (RFE) model; and adjusting operation cycles and operation power of first-type aquaculture apparatuses, second-type aquaculture apparatuses, and third-type aquaculture apparatuses in sequence according to an apparatus type of each aquaculture apparatus, the aquaculture zone where each aquaculture apparatus is located, the predicted wave energy yield, and the importance coefficient value sorting results.

### TECHNICAL FIELD

The present disclosure relates to the technical field of wave energy data processing, in particular to a method and system for controlling and distributing wave energy in offshore aquaculture.

### BACKGROUND

In offshore aquaculture environments, wave energy is extensively utilized as a clean and renewable source of power for aquaculture apparatuses. However, a wave energy yield is affected by various factors such as the height, speed, and direction of waves, and weather conditions. These factors change over time, resulting in volatility of the wave energy yield. Hence, in practical operation, the following problems may arise without effective management and control strategies.

The first problem is resource waste: when the wave energy yield is high, failure to utilize this part of the energy in a timely manner will result in resource waste. The second problem is resource shortage: when the wave energy yield is low, if an aquaculture apparatus still operates in a fixed manner, it may lead to insufficient power supply and affect normal operation of aquaculture activities. The third problem is low apparatus operation efficiency: due to the volatility of the wave energy yield, if apparatus operation parameters remain fixed, it may result in low apparatus operation efficiency during some periods and exceed a required capacity during other periods.

### SUMMARY

Embodiments of the present disclosure provide a method and system for controlling and distributing wave energy in offshore aquaculture, achieving effective utilization of wave energy resources, guaranteeing full utilization of these resources when a wave energy yield is high, and reducing unnecessary energy consumption when the yield is low.

A first aspect of the embodiments of the present application provides a method for controlling and distributing wave energy in offshore aquaculture. The method includes:

obtaining an aquaculture cycle of each aquaculture sub-zone of an offshore aquaculture zone, sorting remaining aquaculture cycles of the aquaculture sub-zones from small to large, and obtaining a plurality of work cycles according to sorting results;

setting an input layer of a preset neural network model into three dimensions, and selecting one long short term memory (LSTM) layer and one gated recurrent unit (GRU) layer to form a hidden layer of the preset neural network model; and setting a plurality of first neurons and one second neuron in an output layer, where each of the first neurons corresponds to one group of sensors deployed offshore, output of the second neuron is a sum of output of all the first neurons, and each group of sensors is responsible for information collection of one ocean subregion;

converting historical ocean data into a three-dimensional tensor, where a first dimension of the three-dimensional tensor is batch sample quantity, and the batch sample quantity is equal to a group number of sensors deployed offshore; a second dimension of the three-dimensional tensor is time step, and the time step is equal to a time span of the historical ocean data; and a third dimension of the three-dimensional tensor is feature quantity;

inputting the three-dimensional tensor into the preset neural network model for training;

obtaining a predicted wave energy yield of a next work cycle through the preset neural network model;

obtaining an importance coefficient value sorting result of each aquaculture zone through a preset recursive feature elimination (RFE) model; and

adjusting operation cycles and operation power of first-type aquaculture apparatuses, second-type aquaculture apparatuses, and third-type aquaculture apparatuses in sequence according to an apparatus type of each aquaculture apparatus, the aquaculture zone where each aquaculture apparatus is located, the predicted wave energy yield, and the importance coefficient value sorting results.

In a possible implementation of the first aspect, the sorting remaining aquaculture cycles of the aquaculture sub-zones from small to large, and obtaining a plurality of work cycles according to sorting results include:

counting the remaining aquaculture cycles of the aquaculture sub-zones;

sorting the plurality of remaining aquaculture cycles from small to large, and taking the first remaining aquaculture cycle as the next work cycle; and

taking, for the remaining aquaculture cycles other than the first remaining aquaculture cycle, an end date of a previous remaining aquaculture cycle as a start date of a corresponding work cycle, and taking an end date of a current remaining aquaculture cycle as an end date of the corresponding work cycle.

In a possible implementation of the first aspect, before the adjusting operation cycles and operation power of first-type aquaculture apparatuses, second-type aquaculture apparatuses, and third-type aquaculture apparatuses in sequence, the method includes:

collecting historical operation data of each aquaculture apparatus;

performing feature extraction on the historical operation data of each aquaculture apparatus, and obtaining corresponding five-dimensional apparatus feature vectors of different aquaculture apparatus, where a first dimension of each five-dimensional apparatus feature vector is apparatus type value, a second dimension of each five-dimensional apparatus feature vector is apparatus working environment value, a third dimension of each five-dimensional apparatus feature vector is apparatus working time value, a fourth dimension of each five-dimensional apparatus feature vector is apparatus latitude and longitude value, and a fifth dimension of each five-dimensional apparatus feature vector is quarterly yield value of an aquaculture farm to which the apparatus belongs; and

performing K-mean clustering on all the five-dimensional apparatus feature vectors, and obtaining three clusters, where the aquaculture apparatuses corresponding to the five-dimensional apparatus feature vectors in the first cluster are first-type aquaculture apparatuses, the aquaculture apparatuses corresponding to the five-dimensional apparatus feature vectors in the second cluster are second-type aquaculture apparatuses, and the aquaculture apparatuses corresponding to the five-dimensional apparatus feature vectors in the third cluster are third-type aquaculture apparatuses.

In a possible implementation of the first aspect, the feature quantity is five, and elements of each array in the three-dimensional tensor are wave height value, wave cycle, wave direction angle, wind speed, and wind direction angle in sequence.

In a possible implementation of the first aspect, the obtaining an importance coefficient value sorting result of each aquaculture zone through a preset RFE model includes:

collecting data of different aquaculture zones to form an aquaculture data set, and taking an aquaculture yield as a target variable;

dividing the aquaculture data set into an aquaculture training set and an aquaculture test set;

using the aquaculture training set to train a preset logistic regression model; and

predicting the aquaculture test set through the logistic regression model, and obtaining importance coefficient sorting results of the plurality of aquaculture zones, where importance coefficients decrease sequentially, and each importance coefficient reflects an influence of the aquaculture zone on the aquaculture yield.

In a possible implementation of the first aspect, the collecting data of different aquaculture zones to form an aquaculture data set includes:

collecting remaining aquaculture cycles, latitude and longitude, dissolved oxygen values, pH values, temperatures, feed types, and artificial intervention degrees of the different aquaculture zones;

handling missing values and outliers in samples; and

performing normalization on numerical features, and obtaining a plurality of samples to form the aquaculture data set.

In a possible implementation of the first aspect, the adjusting operation cycles and operation power of first-type aquaculture apparatuses, second-type aquaculture apparatuses, and third-type aquaculture apparatuses in sequence according to an apparatus type of each aquaculture apparatus, the aquaculture zone where each aquaculture apparatus is located, the predicted wave energy yield, and the importance coefficient value sorting results includes:

counting wave energy required by the first-type aquaculture apparatuses, the second-type aquaculture apparatuses, and the third-type aquaculture apparatuses in the next work cycle;

confirming an importance coefficient value order of the first-type aquaculture apparatuses, an importance coefficient value order of the second-type aquaculture apparatuses, and an importance coefficient value order of the third-type aquaculture apparatuses according to the aquaculture zone where each aquaculture apparatus is located and the importance coefficient value sorting results;

adjusting, in a case where the wave energy required by all the first-type aquaculture apparatuses is greater than the predicted wave energy yield, the operation cycles and the operation power of the first-type aquaculture apparatuses in sequence according to the importance coefficient value order of the first-type aquaculture apparatuses;

adjusting, in a case where the wave energy required by all the first-type aquaculture apparatuses is less than or equal to the predicted wave energy yield and the wave energy required by all the first-type aquaculture apparatuses and all the second-type aquaculture apparatuses is greater than the predicted wave energy yield, the operation cycles and the operation power of the second-type aquaculture apparatuses in sequence according to the importance coefficient value order of the second-type aquaculture apparatuses after operation cycle requirements and operation power requirements of all the first-type aquaculture apparatuses are satisfied; and

adjusting, in a case where the wave energy required by all the first-type aquaculture apparatuses and all the second-type aquaculture apparatuses is less than or equal to the predicted wave energy yield and the wave energy required by all the first-type aquaculture apparatuses, all the second-type aquaculture apparatuses, and all the third-type aquaculture apparatuses is greater than the predicted wave energy yield, the operation cycles and the operation power of the third-type aquaculture apparatuses in sequence according to the importance coefficient value order of the third-type aquaculture apparatuses after operation cycle requirements and operation power requirements of all the first-type aquaculture apparatuses and all the second-type aquaculture apparatuses are satisfied.

In a possible implementation of the first aspect, the first-type aquaculture apparatuses include a water quality monitoring apparatus, a feeding apparatus, and a waste treatment apparatus. The second-type aquaculture apparatuses include an underwater camera monitoring apparatus, a water pump and filtering apparatus, and a disease prevention apparatus. The third-type aquaculture apparatuses include an automatic control apparatus, a greenhouse and incubation apparatus, and an aquaculture processing apparatus.

In a possible implementation of the first aspect, before the adjusting operation cycles and operation power of the first-type aquaculture apparatuses, the second-type aquaculture apparatuses, and the third-type aquaculture apparatuses in sequence, the method further includes:

adjusting operation cycles and operation power of all safety apparatuses, where the safety apparatuses include a lifesaving apparatus, a fire-extinguishing apparatus, and an emergency power supply; and supply power of the emergency power supply is greater than total rated power of all the first-type aquaculture apparatuses.

A second aspect of the embodiments of the present application provides a system for controlling and distributing wave energy in offshore aquaculture. The system includes:

a work cycle module configured to obtain an aquaculture cycle of each aquaculture sub-zone of an offshore aquaculture zone, sort remaining aquaculture cycles of the aquaculture sub-zones from small to large, and obtain a plurality of work cycles according to sorting results;

a wave energy predicting module configured to obtain a predicted wave energy yield of a next work cycle through the preset neural network model;

an importance sorting module configured to obtain an importance coefficient value sorting result of each aquaculture zone through a preset RFE model; and

an apparatus adjusting module configured to adjust operation cycles and operation power of the first-type aquaculture apparatuses, the second-type aquaculture apparatuses, and the third-type aquaculture apparatuses in sequence according to an apparatus type of each aquaculture apparatus, the aquaculture zone where each aquaculture apparatus is located, the predicted wave energy yield, and the importance coefficient value sorting results.

Compared with the prior art, the embodiments of the present disclosure provide a method and system for controlling and distributing wave energy in offshore aquaculture. In a first aspect, the wave energy yield in the next work cycle may be predicted in advance by establishing a prediction model. In this way, an operation plan of the aquaculture apparatuses may be arranged according to a prediction result, such that waste or shortage of resources can be avoided. On the other hand, sorting is performed according to the remaining aquaculture cycles of the aquaculture sub-zones, and then different work cycles are divided according to the sorting results. This can guarantee that requirements of an aquaculture sub-zone coming to an end of an aquaculture cycle is prioritized when the wave energy yield is high, thus improving aquaculture efficiency. On the other hand, according to the predicted wave energy yield and the importance coefficient sorting results of the aquaculture zones, the operation cycles and the operation power of different types of aquaculture apparatuses are adjusted. For example, in a period of a high wave energy yield, the operation power of the apparatuses may be appropriately increased. In a period of a low yield, the operation cycles and power of the apparatuses may be appropriately reduced to save energy.

### BRIEF DESCRIPTION OF THE DRAWINGS

FIG. 1 is a schematic flowchart of a method for controlling and distributing wave energy in offshore aquaculture according to an embodiment of the present disclosure.

FIG. 2 is a schematic structural diagram of a system for controlling and distributing wave energy in offshore aquaculture according to an embodiment of the present disclosure.

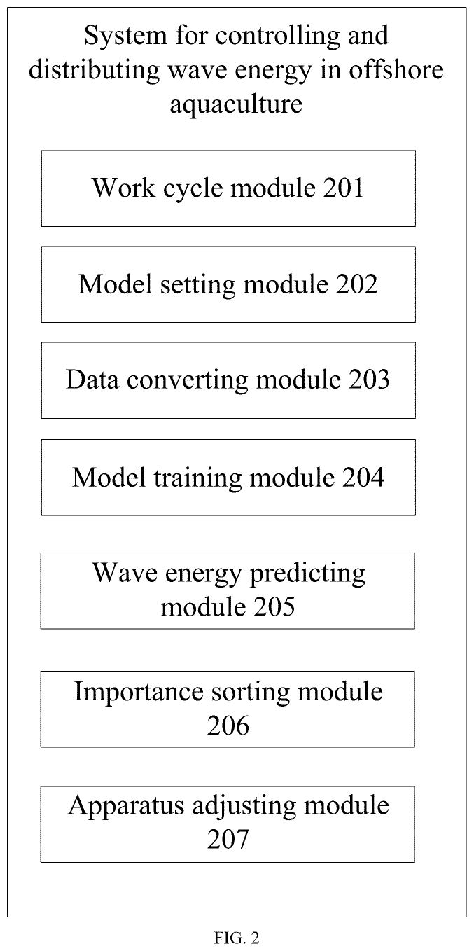

### DETAILED DESCRIPTION OF THE EMBODIMENTS

The technical solutions of the embodiments of the present disclosure are clearly and completely described below with reference to the drawings. Apparently, the described embodiments are merely some embodiments rather than all embodiments of the present disclosure. Based on the embodiments in the present disclosure, all other embodiments derived by those of ordinary skill in the art without creative efforts fall within the protection scope of the present disclosure.

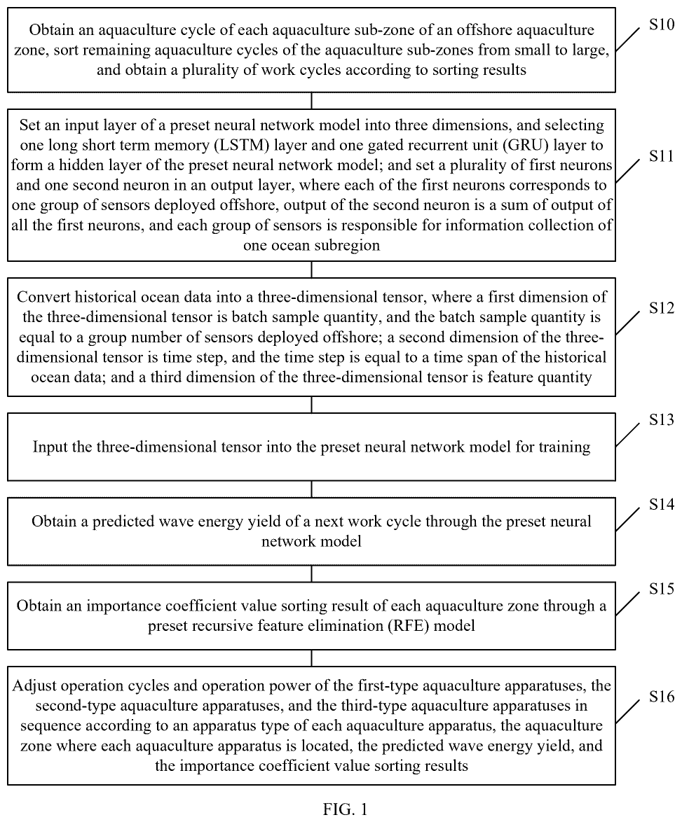

With reference to FIG. 1, the embodiments of the present disclosure provide a method for controlling and distributing wave energy in offshore aquaculture. The method includes:

S10, an aquaculture cycle of each aquaculture sub-zone of an offshore aquaculture zone is obtained, remaining aquaculture cycles of the aquaculture sub-zones are sorted from small to large, and a plurality of work cycles are obtained according to sorting results.

S11, a predicted wave energy yield of a next work cycle is obtained through the preset neural network model.

S12, an importance coefficient value sorting result of each aquaculture zone is obtained through a preset recursive feature elimination (RFE) model.

S13, operation cycles and operation power of first-type aquaculture apparatuses, second-type aquaculture apparatuses, and third-type aquaculture apparatuses are adjusted in sequence according to an apparatus type of each aquaculture apparatus, the aquaculture zone where each aquaculture apparatus is located, the predicted wave energy yield, and the importance coefficient value sorting results.

In S10, the aquaculture cycles are obtained and sorted, aquaculture information of each aquaculture sub-zone is collected, and the remaining aquaculture cycles of the aquaculture sub-zones are sorted from small to large. Different aquaculture sub-zones breed different aquatic products, and complete growth (harvest period) of the corresponding aquatic products have different time requirements. The work cycles are divided according to time lengths near the harvest periods (the remaining aquaculture cycles). This division of the work cycles can give priority to guaranteeing harvest of aquatic products near the harvest periods in each work cycle, to effectively guarantee aquatic product output of an offshore aquaculture plant, and guarantee that wave energy distribution is more reasonable.

In S11, when a neural network model structure is defined, the input layer is set into three dimensions, for example (batch_size, time_steps, and features).

One long short term memory (LSTM) layer and one gated recurrent unit (GRU) layer are set as a hidden layer. By using the neural network model including the LSTM layer and the GRU layer, long-term dependencies in time series data may be better captured, such that accuracy of wave energy yield predictions can be improved.

A plurality of first neurons (each corresponding to one group of sensors) and one second neuron (summing output of all the first neurons) are set as an output layer.

Assuming that in S12, 3 groups of sensors are deployed offshore, each group of sensors collects 5 features (for example, wave height value, wave cycle, wave direction angle, wind speed, and wind direction angle). Assuming that a time span of historical data is 10 time steps, a shape of a three-dimensional tensor is (3, 10, 5).

In S13, the three-dimensional tensor is input into the neural network model for training, and the obtained preset neural network model may predict the wave energy yield of each work cycle. Based on accurate wave energy yield prediction, resource distribution may be planned in advance to guarantee that resources are fully utilized in a period of a high wave energy yield and to avoid resource waste. By accurately predicting the wave energy yield, unnecessary apparatus start-up and shutdown time may be reduced, such that operation costs can be reduced.

In S14, the wave energy yield of the next work cycle is predicted through the trained neural network model. This is to determine whether the wave energy yield can satisfy requirements of an aquaculture apparatus in an aquaculture sub-zone that is about to end the aquaculture cycle. By accurately predicting the wave energy yield, the unnecessary apparatus start-up and shutdown time can be reduced, such that the operation costs are reduced. In S15, by using the recursive feature elimination (RFE) model, critical aquaculture zones can be identified by determining which aquaculture zones have a greater influence on the aquaculture yield. Then, by prioritizing aquaculture zones with higher importance, it can be guaranteed that aquaculture activities in these zones are adequately supported, such that aquaculture efficiency is increased. In S16, by optimizing apparatus operation parameters, it is guaranteed that the aquaculture activities are performed with sufficient resources, thus the aquaculture yield can be increased.

Through S10 to S16, according to the different apparatus types, aquaculture zones where the apparatus are located, the predicted wave energy yield, and the importance coefficient value sorting results, the operation cycles and the operation power of the apparatuses can be finely adjusted to guarantee that the resources are effectively utilized. By reasonably adjusting the operation cycles and the operation power of the apparatuses, the apparatuses can be fully utilized in a period of a high wave energy yield to avoid idle of the apparatuses. By reducing operation of the apparatuses in a period of a low wave energy yield, energy can be saved, and the operation costs can be reduced. By optimizing the apparatus operation parameters, it is guaranteed that the aquaculture activities are performed with sufficient resources, thus the aquaculture yield can be increased.

Illustratively, the remaining aquaculture cycles of the aquaculture sub-zones are sorted from small to large, and the plurality of work cycles are obtained according to the sorting results. This process specifically includes:

The remaining aquaculture cycles of the aquaculture sub-zones are counted.

The plurality of remaining aquaculture cycles are sorted from small to large, and the first remaining aquaculture cycle is taken as the next work cycle.

For the remaining aquaculture cycles other than the first remaining aquaculture cycle, an end date of a previous remaining aquaculture cycle is taken as a start date of a corresponding work cycle, and an end date of a current remaining aquaculture cycle is taken as an end date of the corresponding work cycle.

Effective management and optimization for the aquaculture cycles can be implemented by sorting the remaining aquaculture cycles of the aquaculture sub-zones from small to large and obtaining the plurality work cycles according to the sorting results. This can guarantee that requirements of an aquaculture sub-zone with a shorter aquaculture cycle is prioritized in a period of a higher wave energy yield, thereby increasing the yield efficiency and resource use efficiency.

Assuming that four aquaculture sub-zones are provided, their remaining aquaculture cycles are as follows: aquaculture sub-zone A: 30 days; aquaculture sub-zone B: 45 days; aquaculture sub-zone C: 60 days; and aquaculture sub-zone D: 15 days.

Specific division is as follows:

First work cycle: start date: Day 1; end date: Day 15; and associated aquaculture sub-zone: D.

Second work cycle: start date: Day 16; end date: Day 30; and associated aquaculture sub-zone: A.

Third work cycle: start date: Day 31; end date: Day 45; and aquaculture sub-zone: B.

Fourth work cycle: start date: Day 46; end date: Day 60; and associated aquaculture sub-zone: C.

Illustratively, before the predicted wave energy yield of the next work cycle is obtained through the preset neural network model, the method further includes:

An input layer of a preset neural network model is set into three dimensions, and one LSTM layer and one GRU layer are selected to form a hidden layer of the preset neural network model.

A plurality of first neurons and one second neuron are set in an output layer. Each of the first neurons corresponds to one group of sensors deployed offshore. Output of the second neuron is a sum of output of all the first neurons. Each group of sensors is responsible for information collection of one ocean subregion.

Historical ocean data is converted into a three-dimensional tensor. A first dimension of the three-dimensional tensor is batch sample quantity, and the batch sample quantity is equal to a group number of sensors deployed offshore. A second dimension of the three-dimensional tensor is time step, and the time step is equal to a time span of the historical ocean data. A third dimension of the three-dimensional tensor is feature quantity. Using the three-dimensional tensor containing time series data allows better capture of time dependencies in the data, thereby improving the accuracy of a prediction model.

The three-dimensional tensor is input into the preset neural network model for training.

Illustratively, the feature quantity is five. Elements of each array in the three-dimensional tensor are wave height value, wave cycle, wave direction angle, wind speed, and wind direction angle in sequence.

The wave height value, the wave cycle, the wave direction angle, the wind speed, and the wind direction angle are selected as features because these features are closely related to the wave energy yield. By using features directly related to the wave energy yield, accuracy of the prediction model can be improved. The historical ocean data is then converted into one three-dimensional tensor. Each array represents data of one group of sensors. The elements of each array are the wave height value, the wave cycle, the wave direction angle, the wind speed, and the wind direction angle in sequence.

Assuming that 3 groups of sensors are deployed offshore, each group of sensors collects the 5 features.

Assuming that a time span of historical data is 10 time steps.

A shape of a three-dimensional tensor is (3, 10, 5). The first dimension (3) indicates 3groups of sensors. The second dimension (10) indicates the time step, that is, the time span of the historical data. The third dimension (5) indicates the feature quantity, that is, the wave height value, the wave cycle, the wave direction angle, the wind speed, and the wind direction angle.

Illustratively, before the operation cycles and the operation power of the first-type aquaculture apparatuses, the second-type aquaculture apparatuses, and the third-type aquaculture apparatuses are adjusted in sequence, the method includes:

Historical operation data of each aquaculture apparatus is collected.

Feature extraction is performed on the historical operation data of each aquaculture apparatus, and corresponding five-dimensional apparatus feature vectors of different aquaculture apparatus are obtained. A first dimension of each five-dimensional apparatus feature vector is apparatus type value. A second dimension of each five-dimensional apparatus feature vector is apparatus working environment value. A third dimension of each five-dimensional apparatus feature vector is apparatus working time value. A fourth dimension of each five-dimensional apparatus feature vector is apparatus latitude and longitude value. A fifth dimension of each five-dimensional apparatus feature vector is quarterly yield value of an aquaculture farm to which the apparatus belongs.

K-mean clustering is performed on all the five-dimensional apparatus feature vectors, and three clusters are obtained. The aquaculture apparatuses corresponding to the five-dimensional apparatus feature vectors in the first cluster are first-type aquaculture apparatuses. The aquaculture apparatuses corresponding to the five-dimensional apparatus feature vectors in the second cluster are second-type aquaculture apparatuses. The aquaculture apparatuses corresponding to the five-dimensional apparatus feature vectors in the third cluster are third-type aquaculture apparatuses.

The first dimension of the five-dimensional apparatus feature vector is the apparatus type value (for example, 1=water quality monitoring apparatus, 2=feeding apparatus, and 3=waste treatment apparatus). The second dimension of the five-dimensional apparatus feature vector is the apparatus working environment value (for example, temperature, humidity, and pH value). The third dimension of the five-dimensional apparatus feature vector is the apparatus working time value (for example, working time per day, and working time in a past week). The fourth dimension of the five-dimensional apparatus feature vector is the apparatus latitude and longitude value (for example, geographical location coordinates of an apparatus). The fifth dimension of the five-dimensional apparatus feature vector is the quarterly yield value of an aquaculture farm to which the apparatus belongs (for example, a yield in a most recent quarter).

K-mean clustering is performed on all the five-dimensional apparatus feature vectors. An appropriate clustering number K is typically determined through an elbow rule or a contour coefficient. A K-mean algorithm is run to obtain a list of different cluster centers and apparatuses belonging to clusters. In this example, K=3, which means that the apparatuses are divided into three clusters. According to clustering results, the apparatuses may be divided into the first-type aquaculture apparatuses, the second-type aquaculture apparatuses, and the third-type aquaculture apparatuses.

Through K-mean clustering, the apparatuses may be classified according to similarity. This is convenient for subsequent resource distribution and management. In terms of optimizing resource distribution: based on the clustering results, effects of different types of apparatuses in aquaculture can be better understood, such that resource distribution can be optimized. In terms of increasing aquaculture efficiency: by classifying the apparatuses, the apparatuses can be managed more effectively, and the aquaculture efficiency can be increased.

Illustratively, the importance coefficient value sorting result of each aquaculture zone is obtained through the preset RFE model. This process specifically includes:

Data of different aquaculture zones is collected to form an aquaculture data set, and an aquaculture yield is taken as a target variable.

The aquaculture data set is divided into an aquaculture training set and an aquaculture test set.

The aquaculture training set is used to train a preset logistic regression model.

The aquaculture test set is predicted through the logistic regression model, and importance coefficient sorting results of the plurality of aquaculture zones are obtained. Importance coefficients decrease sequentially. Each importance coefficient reflects an influence of the aquaculture zone on the aquaculture yield.

By using the recursive feature elimination (RFE) model, critical aquaculture zones can be identified by determining which aquaculture zones have a greater influence on the aquaculture yield. Based on the importance coefficient sorting results of the aquaculture zones, by prioritizing aquaculture zones with higher importance, it can be guaranteed that aquaculture activities in these zones are adequately supported, such that aquaculture efficiency is increased.

Illustratively, the data of the different aquaculture zones is collected to form an aquaculture data set. The process specifically includes:

Remaining aquaculture cycles, latitude and longitude, dissolved oxygen values, pH values, temperatures, feed types, and artificial intervention degrees of the different aquaculture zones are collected.

Missing values and outliers in samples are handled.

Normalization is performed on numerical features, and a plurality of samples to form the aquaculture data set are obtained.

When the remaining aquaculture cycles, the latitude and longitude, the dissolved oxygen values, the pH values, the temperatures, the feed types, and the artificial intervention degrees of the different aquaculture zones are collected, they may be obtained through field survey, historical record, or sensor collection.

Handling the missing values and the outliers in the samples requires appropriate filling methods, such as mean, median, or mode filling. In a process of identifying and handling the outliers, an interquartile range (IQR) method or other statistical methods can be used to identify and handle the outliers. Normalization for the numerical features is to unify the features of different scales into a same range. Methods that may be used include min-max normalization or Z-score normalization.

By collecting relevant data from different aquaculture zones and performing appropriate pretreatment, the aquaculture data set may be effectively formed. This helps to improve accuracy of a logistic regression model, then the importance coefficient sorting results of the aquaculture zones can be better determined, resource distribution can be optimized, and the aquaculture efficiency can be increased.

Illustratively, the operation cycles and the operation power of the first-type aquaculture apparatuses, the second-type aquaculture apparatuses, and the third-type aquaculture apparatuses are adjusted in sequence according to an apparatus type of each aquaculture apparatus, the aquaculture zone where each aquaculture apparatus is located, the predicted wave energy yield, and the importance coefficient value sorting results. This process specifically includes:

Wave energy required by the first-type aquaculture apparatuses, the second-type aquaculture apparatuses, and the third-type aquaculture apparatuses in the next work cycle is counted.

An importance coefficient value order of the first-type aquaculture apparatuses, an importance coefficient value order of the second-type aquaculture apparatuses, and an importance coefficient value order of the third-type aquaculture apparatuses are confirmed according to the aquaculture zone where each aquaculture apparatus is located and the importance coefficient value sorting results.

In a case where the wave energy required by all the first-type aquaculture apparatuses is greater than the predicted wave energy yield, the operation cycles and the operation power of the first-type aquaculture apparatuses are adjusted in sequence according to the importance coefficient value order of the first-type aquaculture apparatuses.

In a case where the wave energy required by all the first-type aquaculture apparatuses is less than or equal to the predicted wave energy yield and the wave energy required by all the first-type aquaculture apparatuses and all the second-type aquaculture apparatuses is greater than the predicted wave energy yield, the operation cycles and the operation power of the second-type aquaculture apparatuses are adjusted in sequence according to the importance coefficient value order of the second-type aquaculture apparatuses after operation cycle requirements and operation power requirements of all the first-type aquaculture apparatuses are satisfied.

In a case where the wave energy required by all the first-type aquaculture apparatuses and all the second-type aquaculture apparatuses is less than or equal to the predicted wave energy yield and the wave energy required by all the first-type aquaculture apparatuses, all the second-type aquaculture apparatuses, and all the third-type aquaculture apparatuses is greater than the predicted wave energy yield, the operation cycles and the operation power of the third-type aquaculture apparatuses are adjusted in sequence according to the importance coefficient value order of the third-type aquaculture apparatuses after operation cycle requirements and operation power requirements of all the first-type aquaculture apparatuses and all the second-type aquaculture apparatuses are satisfied.

Assuming that total wave energy required by the first-type aquaculture apparatuses is 80 kWh, total wave energy required by the second-type aquaculture apparatuses is 60 kWh, and total wave energy required by the third-type aquaculture apparatuses is 40 kWh, and then assuming that the predicted wave energy yield is 150 kWh, according to the importance coefficient value sorting results of the aquaculture zones, the importance coefficient value order of the first-type aquaculture apparatuses is A>B>C, the importance coefficient value order of the second-type aquaculture apparatuses is D>E>F, and the importance coefficient value order of the third-type aquaculture apparatuses is G>H>I.

Then, when the apparatus operation parameters are specifically adjusted, reference may be made to the following methods:

Since the wave energy required by all the first-type aquaculture apparatuses is 80 kWh, which is less than the predicted wave energy yield of 150 kWh, the operation cycles and operation power of the apparatuses A, B, and C are adjusted in sequence according to the importance coefficient value order.

Since the wave energy required by all the first-type aquaculture apparatuses and the second-type aquaculture apparatuses is 140 kWh, which is less than the predicted wave energy yield of 150 kWh, after the requirements of the first-type aquaculture apparatuses are satisfied, operation cycles and operation power of the apparatuses D, E, and F are adjusted in sequence according to the importance coefficient value order.

Since the wave energy required by all the first-type aquaculture apparatuses, the second-type aquaculture apparatuses, and the third-type aquaculture apparatuses is 180 kWh, which is greater than the predicted wave energy yield of 150 kWh, after the requirements of the first-type aquaculture apparatuses and the second-type aquaculture apparatuses are satisfied, operation cycles and operation power of the apparatuses G, H, and I are adjusted in sequence according to the importance coefficient value order until the wave energy distribution is completed. In a case where a remaining wave energy yield after the operation cycle and the operation power of the apparatus G is adjusted is insufficient, the operation cycles and the operation power of the apparatuses H and I are maintained at 0.

Illustratively, the first-type aquaculture apparatuses include a water quality monitoring apparatus, a feeding apparatus, and a waste treatment apparatus. The second-type aquaculture apparatuses include an underwater camera monitoring apparatus, a water pump and filtering apparatus, and a disease prevention apparatus. The third-type aquaculture apparatuses include an automatic control apparatus, a greenhouse and incubation apparatus, and an aquaculture processing apparatus.

It should be noted that the first-type aquaculture apparatuses are crucial to basic operation maintaining of the aquaculture zones, and any failure may lead to significant economic losses or ecological disasters. The second-type aquaculture apparatuses are important for daily operations, and their failure influences the aquaculture efficiency, but does not immediately cause catastrophic consequences. The third-type aquaculture apparatuses belong to auxiliary equipment, although they are not necessary, but they play an active role in increasing the aquaculture efficiency and reducing labor intensity.

Illustratively, before the operation cycles and the operation power of the first-type aquaculture apparatuses, the second-type aquaculture apparatuses, and the third-type aquaculture apparatuses are adjusted in sequence, the method further includes:

Operation cycles and operation power of all safety apparatuses are adjusted. The safety apparatuses include a lifesaving apparatus, a fire-extinguishing apparatus, and an emergency power supply. Supply power of the emergency power supply is greater than total rated power of all the first-type aquaculture apparatuses.

Compared with the prior art, the embodiments of the present disclosure provide the method for controlling and distributing wave energy in offshore aquaculture. In a first aspect, the wave energy yield in the next work cycle can be predicted in advance by establishing a prediction model. In this way, an operation plan of the aquaculture apparatuses can be arranged according to a prediction result, such that waste or shortage of resources can be avoided. On the other hand, sorting is performed according to the remaining aquaculture cycles of the aquaculture sub-zones, and then different work cycles are divided according to the sorting results. This can guarantee that requirements of an aquaculture sub-zone coming to an end of an aquaculture cycle is prioritized when the wave energy yield is high, thus improving aquaculture efficiency. On the other hand, according to the predicted wave energy yield and the importance coefficient sorting results of the aquaculture zones, the operation cycles and the operation power of different types of aquaculture apparatuses are adjusted. For example, in a period of a high wave energy yield, the operation power of the apparatuses may be appropriately increased. In a period of a low yield, the operation cycles and power of the apparatuses may be appropriately reduced to save energy.

An embodiment of the present application provides a system for controlling and distributing wave energy in offshore aquaculture. The system includes a work cycle module 201, a model setting module 202, a data converting module 203, a model training module 204, a wave energy predicting module 205, an importance sorting module 206, and an apparatus adjusting module 207.

The work cycle module 201 is configured to obtain an aquaculture cycle of each aquaculture sub-zone of an offshore aquaculture zone, sort remaining aquaculture cycles of the aquaculture sub-zones from small to large, and obtain a plurality of work cycles according to sorting results.

The model setting module 202 is configured to set an input layer of a preset neural network model into three dimensions, and select one long short term memory (LSTM) layer and one gated recurrent unit (GRU) layer to form a hidden layer of the preset neural network model; and set a plurality of first neurons and one second neuron in an output layer. Each of the first neurons corresponds to one group of sensors deployed offshore. Output of the second neuron is a sum of output of all the first neurons. Each group of sensors is responsible for information collection of one ocean subregion.

The data converting module 203 is configured to convert historical ocean data into a three-dimensional tensor. A first dimension of the three-dimensional tensor is batch sample quantity, and the batch sample quantity is equal to a group number of sensors deployed offshore. A second dimension of the three-dimensional tensor is time step, and the time step is equal to a time span of the historical ocean data. A third dimension of the three-dimensional tensor is feature quantity.

The model training module 204 is configured to input the three-dimensional tensor into the preset neural network model for training.

The wave energy predicting module 205 is configured to obtain a predicted wave energy yield of a next work cycle through the preset neural network model.

The importance sorting module 206 is configured to obtain an importance coefficient value sorting result of each aquaculture zone through a preset RFE model.

The apparatus adjusting module 207 is configured to adjust operation cycles and operation power of the first-type aquaculture apparatuses, the second-type aquaculture apparatuses, and the third-type aquaculture apparatuses in sequence according to an apparatus type of each aquaculture apparatus, the aquaculture zone where each aquaculture apparatus is located, the predicted wave energy yield, and the importance coefficient value sorting results. Those skilled in the art will clearly appreciate that, for convenience and conciseness of description, reference can be made to corresponding processes in the foregoing method embodiments for specific working processes of the above system for controlling and distributing wave energy in offshore aquaculture, which is not repeated herein.

Compared with the prior art, the embodiment of the present disclosure provides the system for controlling and distributing wave energy in offshore aquaculture. In a first aspect, the wave energy yield in the next work cycle may be predicted in advance by establishing a prediction model. In this way, an operation plan of the aquaculture apparatuses may be arranged according to a prediction result, such that waste or shortage of resources can be avoided. On the other hand, sorting is performed according to the remaining aquaculture cycles of the aquaculture sub-zones, and then different work cycles are divided according to the sorting results. This can guarantee that requirements of an aquaculture sub-zone coming to an end of an aquaculture cycle is prioritized when the wave energy yield is high, thus improving aquaculture efficiency. On the other hand, according to the predicted wave energy yield and the importance coefficient sorting results of the aquaculture zones, the operation cycles and the operation power of different types of aquaculture apparatuses are adjusted. For example, in a period of a high wave energy yield, the operation power of the apparatuses may be appropriately increased. In a period of a low yield, the operation cycles and power of the apparatuses may be appropriately reduced to save energy.

The above descriptions are merely preferred implementations of the present disclosure. It should be noted that those of ordinary skill in the art may further make several improvements and modifications without departing from the principle of the present disclosure, but such improvements and modifications should be deemed as falling within the scope of protection of the present disclosure.

What is claimed is:

1. A method for controlling and distributing wave energy in offshore aquaculture, comprising:
obtaining an aquaculture cycle of each aquaculture sub-zone of an offshore aquaculture zone, sorting remaining aquaculture cycles of the aquaculture sub-zones from small to large, and obtaining a plurality of work cycles according to sorting results;
setting an input layer of a preset neural network model into three dimensions, and selecting one long short term memory (LSTM) layer and one gated recurrent unit (GRU) layer to form a hidden layer of the preset neural network model; and setting a plurality of first neurons and one second neuron in an output layer, wherein each of the first neurons corresponds to one group of sensors deployed offshore, output of the second neuron is a sum of output of all the first neurons, and each group of sensors is responsible for information collection of one ocean subregion;
converting historical ocean data into a three-dimensional tensor, wherein a first dimension of the three-dimensional tensor is batch sample quantity, and the batch sample quantity is equal to a group number of sensors deployed offshore; a second dimension of the three-dimensional tensor is time step, and the time step is equal to a time span of the historical ocean data; and a third dimension of the three-dimensional tensor is feature quantity;
inputting the three-dimensional tensor into the preset neural network model for training;
obtaining a predicted wave energy yield of a next work cycle through the preset neural network model;
obtaining an importance coefficient value sorting result of each aquaculture zone through a preset recursive feature elimination model, wherein the step comprises: collecting data of different aquaculture zones to form an aquaculture data set, and taking an aquaculture yield as a target variable; dividing the aquaculture data set into an aquaculture training set and an aquaculture test set; using the aquaculture training set to train a preset logistic regression model; and predicting the aquaculture test set through the logistic regression model, and obtaining importance coefficient sorting results of the plurality of aquaculture zones, wherein importance coefficients decrease sequentially, and each importance coefficient reflects an influence of the aquaculture zone on the aquaculture yield;
collecting historical operation data of each aquaculture apparatus; performing feature extraction on the historical operation data of each aquaculture apparatus, and obtaining corresponding five-dimensional apparatus feature vectors of different aquaculture apparatus, wherein a first dimension of each five-dimensional apparatus feature vector is apparatus type value, a second dimension of each five-dimensional apparatus feature vector is apparatus working environment value, a third dimension of each five-dimensional apparatus feature vector is apparatus working time value, a fourth dimension of each five-dimensional apparatus feature vector is apparatus latitude and longitude value, and a fifth dimension of each five-dimensional apparatus feature vector is quarterly yield value of an aquaculture farm to which the apparatus belongs; and performing K-mean clustering on all the five-dimensional apparatus feature vectors, and obtaining three clusters, wherein the aquaculture apparatuses corresponding to the five-dimensional apparatus feature vectors in the first cluster are first-type aquaculture apparatuses, the aquaculture apparatuses corresponding to the five-dimensional apparatus feature vectors in the second cluster are second-type aquaculture apparatuses, and the aquaculture apparatuses corresponding to the five-dimensional apparatus feature vectors in the third cluster are third-type aquaculture apparatuses; and
adjusting operation cycles and operation power of the first-type aquaculture apparatuses, the second-type aquaculture apparatuses, and the third-type aquaculture apparatuses in sequence according to an apparatus type of each aquaculture apparatus, the aquaculture zone where each aquaculture apparatus is located, the predicted wave energy yield, and the importance coefficient value sorting results, wherein the step comprises:
counting wave energy required by the first-type aquaculture apparatuses, the second-type aquaculture apparatuses, and the third-type aquaculture apparatuses in the next work cycle, wherein the first-type aquaculture apparatuses comprise a water quality monitoring apparatus, a feeding apparatus, and a waste treatment apparatus, the second-type aquaculture apparatuses comprise an underwater camera monitoring apparatus, a water pump and filtering apparatus, and a disease prevention apparatus, and the third-type aquaculture apparatuses comprise an automatic control apparatus, a greenhouse and incubation apparatus, and an aquaculture processing apparatus;
confirming an importance coefficient value order of the first-type aquaculture apparatuses, an importance coefficient value order of the second-type aquaculture apparatuses, and an importance coefficient value order of the third-type aquaculture apparatuses according to the aquaculture zone where each aquaculture apparatus is located and the importance coefficient value sorting results;
adjusting, in a case where the wave energy required by all the first-type aquaculture apparatuses is greater than the predicted wave energy yield, the operation cycles and the operation power of the first-type aquaculture apparatuses in sequence according to the importance coefficient value order of the first-type aquaculture apparatuses;
adjusting, in a case where the wave energy required by all the first-type aquaculture apparatuses is less than or equal to the predicted wave energy yield and the wave energy required by all the first-type aquaculture apparatuses and all the second-type aquaculture apparatuses is greater than the predicted wave energy yield, the operation cycles and the operation power of the second-type aquaculture apparatuses in sequence according to the importance coefficient value order of the second-type aquaculture apparatuses after operation cycle requirements and operation power requirements of all the first-type aquaculture apparatuses are satisfied; and
adjusting, in a case where the wave energy required by all the first-type aquaculture apparatuses and all the second-type aquaculture apparatuses is less than or equal to the predicted wave energy yield and the wave energy required by all the first-type aquaculture apparatuses, all the second-type aquaculture apparatuses, and all the third-type aquaculture apparatuses is greater than the predicted wave energy yield, the operation cycles and the operation power of the third-type aquaculture apparatuses in sequence according to the importance coefficient value order of the third-type aquaculture apparatuses after operation cycle requirements and operation power requirements of all the first-type aquaculture apparatuses and all the second-type aquaculture apparatuses are satisfied.

2. The method for controlling and distributing wave energy in offshore aquaculture according to claim 1, wherein the sorting remaining aquaculture cycles of the aquaculture sub-zones from small to large, and obtaining a plurality of work cycles according to sorting results comprise:
counting the remaining aquaculture cycles of the aquaculture sub-zones;
sorting the plurality of remaining aquaculture cycles from small to large, and taking the first remaining aquaculture cycle as the next work cycle; and
taking, for the remaining aquaculture cycles other than the first remaining aquaculture cycle, an end date of a previous remaining aquaculture cycle as a start date of a corresponding work cycle, and taking an end date of a current remaining aquaculture cycle as an end date of the corresponding work cycle.

3. The method for controlling and distributing wave energy in offshore aquaculture according to claim 1, wherein the feature quantity is five, and elements of each array in the three-dimensional tensor are wave height value, wave cycle, wave direction angle, wind speed, and wind direction angle in sequence.

4. The method for controlling and distributing wave energy in offshore aquaculture according to claim 1, wherein the collecting data of different aquaculture zones to form an aquaculture data set comprises:
collecting remaining aquaculture cycles, latitude and longitude, dissolved oxygen values, pH values, temperatures, feed types, and artificial intervention degrees of the different aquaculture zones;
handling missing values and outliers in samples; and
performing normalization on numerical features, and obtaining a plurality of samples to form the aquaculture data set.

5. The method for controlling and distributing wave energy in offshore aquaculture according to claim 1, wherein before the adjusting operation cycles and operation power of the first-type aquaculture apparatuses, the second-type aquaculture apparatuses, and the third-type aquaculture apparatuses in sequence, the method comprises:
adjusting operation cycles and operation power of all safety apparatuses, wherein the safety apparatuses comprise a lifesaving apparatus, a fire-extinguishing apparatus, and an emergency power supply; and supply power of the emergency power supply is greater than total rated power of all the first-type aquaculture apparatuses.

6. A system for controlling and distributing wave energy in offshore aquaculture, comprising:
a work cycle module configured to obtain an aquaculture cycle of each aquaculture sub-zone of an offshore aquaculture zone, sort remaining aquaculture cycles of the aquaculture sub-zones from small to large, and obtain a plurality of work cycles according to sorting results;
a model setting module configured to set an input layer of a preset neural network model into three dimensions, and select one long short term memory (LSTM) layer and one gated recurrent unit (GRU) layer to form a hidden layer of the preset neural network model; and set a plurality of first neurons and one second neuron in an output layer, wherein each of the first neurons corresponds to one group of sensors deployed offshore, output of the second neuron is a sum of output of all the first neurons, and each group of sensors is responsible for information collection of one ocean subregion;
a data converting module configured to convert historical ocean data into a three-dimensional tensor, wherein a first dimension of the three-dimensional tensor is batch sample quantity, and the batch sample quantity is equal to a group number of sensors deployed offshore;
a second dimension of the three-dimensional tensor is time step, and the time step is equal to a time span of the historical ocean data; and a third dimension of the three-dimensional tensor is feature quantity;
a model training module configured to input the three-dimensional tensor into the preset neural network model for training;
a wave energy predicting module configured to obtain a predicted wave energy yield of a next work cycle through the preset neural network model;
an importance sorting module configured to obtain an importance coefficient value sorting result of each aquaculture zone through a preset recursive feature elimination model;
an apparatus adjusting module configured to collect historical operation data of each aquaculture apparatus; perform feature extraction on the historical operation data of each aquaculture apparatus, and obtain corresponding five-dimensional apparatus feature vectors of different aquaculture apparatus, wherein a first dimension of each five-dimensional apparatus feature vector is apparatus type value, a second dimension of each five-dimensional apparatus feature vector is apparatus working environment value, a third dimension of each five-dimensional apparatus feature vector is apparatus working time value, a fourth dimension of each five-dimensional apparatus feature vector is apparatus latitude and longitude value, and a fifth dimension of each five-dimensional apparatus feature vector is quarterly yield value of an aquaculture farm to which the apparatus belongs; perform K-mean clustering on all the five-dimensional apparatus feature vectors, and obtain three clusters, wherein the aquaculture apparatuses corresponding to the five-dimensional apparatus feature vectors in the first cluster are first-type aquaculture apparatuses, the aquaculture apparatuses corresponding to the five-dimensional apparatus feature vectors in the second cluster are second-type aquaculture apparatuses, and the aquaculture apparatuses corresponding to the five-dimensional apparatus feature vectors in the third cluster are third-type aquaculture apparatuses; adjust operation cycles and operation power of the first-type aquaculture apparatuses, the second-type aquaculture apparatuses, and the third-type aquaculture apparatuses in sequence according to an apparatus type of each aquaculture apparatus, the aquaculture zone where each aquaculture apparatus is located, the predicted wave energy yield, and the importance coefficient value sorting results, wherein the module is configured to:
count wave energy required by the first-type aquaculture apparatuses, the second-type aquaculture apparatuses, and the third-type aquaculture apparatuses in the next work cycle, wherein the first-type aquaculture apparatuses comprise a water quality monitoring apparatus, a feeding apparatus, and a waste treatment apparatus, the second-type aquaculture apparatuses comprise an underwater camera monitoring apparatus, a water pump and filtering apparatus, and a disease prevention apparatus, and the third-type aquaculture apparatuses comprise an automatic control apparatus, a greenhouse and incubation apparatus, and an aquaculture processing apparatus;
confirm an importance coefficient value order of the first-type aquaculture apparatuses, an importance coefficient value order of the second-type aquaculture apparatuses, and an importance coefficient value order of the third-type aquaculture apparatuses according to the aquaculture zone where each aquaculture apparatus is located and the importance coefficient value sorting results;
adjust, in a case where the wave energy required by all the first-type aquaculture apparatuses is greater than the predicted wave energy yield, the operation cycles and the operation power of the first-type aquaculture apparatuses in sequence according to the importance coefficient value order of the first-type aquaculture apparatuses;
adjust, in a case where the wave energy required by all the first-type aquaculture apparatuses is less than or equal to the predicted wave energy yield and the wave energy required by all the first-type aquaculture apparatuses and all the second-type aquaculture apparatuses is greater than the predicted wave energy yield, the operation cycles and the operation power of the second-type aquaculture apparatuses in sequence according to the importance coefficient value order of the second-type aquaculture apparatuses after operation cycle requirements and operation power requirements of all the first-type aquaculture apparatuses are satisfied; and
adjust, in a case where the wave energy required by all the first-type aquaculture apparatuses and all the second-type aquaculture apparatuses is less than or equal to the predicted wave energy yield and the wave energy required by all the first-type aquaculture apparatuses, all the second-type aquaculture apparatuses, and all the third-type aquaculture apparatuses is greater than the predicted wave energy yield, the operation cycles and the operation power of the third-type aquaculture apparatuses in sequence according to the importance coefficient value order of the third-type aquaculture apparatuses after operation cycle requirements and operation power requirements of all the first-type aquaculture apparatuses and all the second-type aquaculture apparatuses are satisfied.
